(19) United States
(12) Patent Application Publication
(10) Pub. No.: US 2019/0172021 A1
(43) Pub. Date: Jun. 6, 2019

(54) Distributed Ledger Applications

(71) Applicant: DIEBOLD NIXDORF, INCORPORATED, NORTH CANTON, OH (US)

(72) Inventors: Devon Watson, North Canton, OH (US); Douglas Kurt HARTUNG, Kingwood, TX (US); Vanessa Gagnon, Stow, OH (US); Gregory Shimek, Akron, OH (US); Gary A. Ganger, Uniontown, OH (US)

(21) Appl. No.: 16/309,994

(22) PCT Filed: Jul. 14, 2017
(86) PCT No.: PCT/US17/42163

§ 371 Date: Dec. 14, 2018

Related U.S. Application Data
(60) Provisional application No. 62/362,378, filed on Jul. 14, 2016.
(60) Provisional application No. 62/431,150, filed on Dec. 7, 2016.
(60) Provisional application No. 62/440,489, filed on Dec. 30, 2016.
(60) Provisional application No. 62/440,492, filed on Dec. 30, 2016.
(60) Provisional application No. 62/429,416, filed on Dec. 2, 2016.

(51) Int. Cl. G06Q 10/00; G07F 19/00; G06F 16/182; H04L 29/08; H04L 9/06

(52) U.S. Cl. CPC G06Q 10/20; G07F 19/209; G07F 19/201; H04L 2209/38; H04L 67/10; H04L 67/18; H04L 9/0637; G06F 16/182

(57) ABSTRACT

In accordance with an example embodiment, there is disclosed herein an example of using a distributed ledger to track a chain of custody. In accordance with another example embodiment, there is disclosed herein an example of using a distributed ledger that can allow for aggregation of data from multiple sources while maintaining without disclosing the source of individual data records. In yet another example embodiment, there is disclosed herein an example of using a distributed ledger for smart financial institution products such as loan origination. In still yet another example embodiment, there is described herein an example of using a distributed ledger to track debt information.

### CROSS REFERENCE TO RELATED APPLICATIONS

This application claims the benefit under 35 U.S.C. § 119 of U.S. Provisional Applications Nos. 62/362,378, filed Jul. 14, 2016; 62/431,150 filed on Dec. 7, 2016; 62/440,489 filed on Dec. 30, 2016; 62/440,492 filed on Dec. 30, 2016; and 62/429,416 filed on Dec. 2, 2016. The contents of the aforementioned application/s is/are hereby incorporated by reference herein in its/their entirety.

### TECHNICAL FIELD

The present disclosure relates generally to various uses of a distributed ledger.

### BACKGROUND

A distributed ledger (also called shared ledger) is a consensus of replicated, shared, and synchronized digital data geographically spread across multiple sites, countries, or institutions. There is no central administrator or centralized data storage. Blockchain technology is an example of a distributed ledger. Although the examples described herein may frequently refer to a Blockchain, those skilled in the art can readily appreciate that any suitable distributed ledger technology may be employed.

### BRIEF DESCRIPTION OF THE DRAWINGS

The accompanying drawings incorporated herein and forming a part of the specification illustrate the example embodiments.

FIG. 1 is a block diagram illustrating an example of a system using a distributed ledger to maintain a chain of custody.

FIG. 2 is an example of data stored in blocks of the chain of custody described in FIG. 1

FIG. 3 is an example of a method for employing a distributed ledger for maintaining a chain of custody

FIG. 4 is an example of a method us using a distributed ledger for aggregating records in a chain of custody.

FIG. 5 is a block diagram illustrating an example of a system using a distributed ledger for a smart contract.

FIG. 6 is an example of a method of using a distributed ledger for smart contracts.

FIG. 7 is an example of a computer system upon which an example embodiment is implemented.

### OVERVIEW OF EXAMPLE EMBODIMENTS

The following presents a simplified overview of the example embodiments in order to provide a basic understanding of some aspects of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented later.

In accordance with an example embodiment, there is disclosed herein an example of using a distributed ledger to track a chain of custody. In accordance with another example embodiment, there is disclosed herein an example of using a distributed ledger that can allow for aggregation of data from multiple sources while maintaining without disclosing the source of individual data records. In yet another example embodiment, there is disclosed herein an example of using a distributed ledger for smart financial institution products such as loan origination. In still yet another example embodiment, there is described herein an example of using a distributed ledger to track debt information.

### DESCRIPTION OF EXAMPLE EMBODIMENTS

This description provides examples not intended to limit the scope of the appended claims. The figures generally indicate the features of the examples, where it is understood and appreciated that like reference numerals are used to refer to like elements. Reference in the specification to “one embodiment” or “an embodiment” or “an example embodiment” means that a particular feature, structure, or characteristic described is included in at least one embodiment described herein and does not imply that the feature, structure, or characteristic is present in all embodiments described herein.

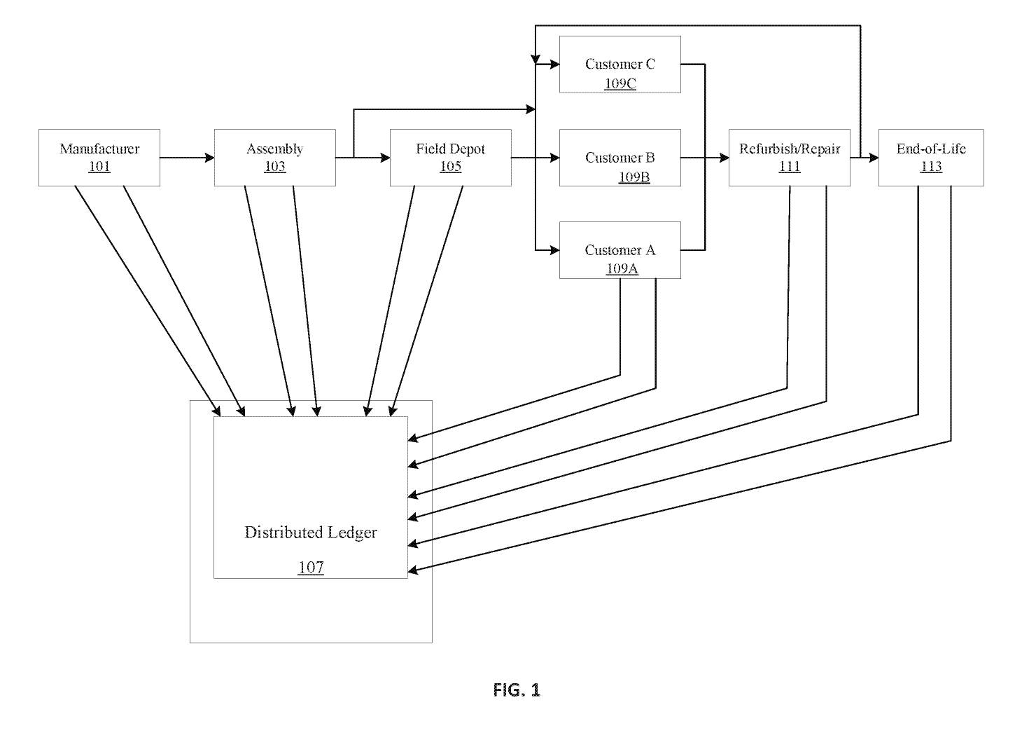

FIG. 1 is a block diagram illustrating an example of a system 100 using a distributed ledger to maintain a chain of custody. In an example embodiment, physical automated teller machine (ATM) modules may move between facilities in the supply chain as illustrated in FIG. 1. Facilities (or node) in the supply chain have logic that acts as a node in a semi-private peer-to-peer network. “Logic”, as used herein, includes but is not limited to hardware, firmware, software and/or combinations of each to perform a function(s) or an action(s), and/or to cause a function or action from another component. For example, based on a desired application or need, logic may include a software controlled microprocessor, discrete logic such as an application specific integrated circuit (ASIC), a programmable/programmed logic device, memory device containing instructions, or the like, or combinational logic embodied in hardware. Logic may also be fully embodied as software that performs the desired functionality when executed by a processor.

In an example embodiment, the nodes maintains a synchronized local copy of a “Distributed Ledger” which is used to immutably record the history and movement of an ATM module as it transitions from facility to facility in the supply chain. All nodes can view and search the ledger and send cryptographically signed messages to each other and to ATM module proxies called Smart Entries residing in the ledger.

Nodes cause PKI (Public Key/Private Key) cryptography to interact with other nodes and the ledger. The nodes create a private and public key pair where the public key is used to produce a unique network address to represent its self on the network. This address is used in message interchanges. The private key is hashed (SHA256) with any message data that will be sent on the network to form a per transaction unique digital signature that can be verified by a receiver to establish trust.

When an ATM module enters the supply chain the manufacturer 101 creates a message that is stored in the ledger 107 that causes the creation of an entry into the distributed ledger for the module. In an example embodiment, contained in the message is a hash (e.g., a SA256 hash) of data, which may be stored in a file (e.g., ID.txt) which contains unique identifying data collected from the hardware (e.g., firmware data, type of device, device serial number). The entry created is unique to the module being tracked and maintains the current state of the module through its flow in the supply chain. The entry also can be programmed to perform logical operations such as message signature verifications and state updates among other things.

At each transition between facilities as an ATM module arrives and leaves the facility or facility operator will create a signed message and send it to the module's Smart Entry surrogate to inform the ledger of the transition. As the module enters the facility the unique identifying data (e.g., ID.txt) is extracted from the physical device, hashed, a message is built, signed and sent to be entered on the ledger. If the ID matches a module in the ledger, the location and history is updated. If it does not the error is returned to the facility.

For example, as the ATM module is being assembled, the assembly node 103 can update the distributed ledger 107. If the module is shipped to a supplier, a supplier node (Field Depot) 105 may update the distributed ledger. When the ATM is module is installed in a financial institution's ATM, nodes associated with the financial institution (e.g., Customer A, 109A, Customer B, 109B, and Customer C 19C in this example). Data entered into the distributed ledger 107 may include service data from either the customer or vendors employed by the customer to service the machine.

If the ATM module is returned to the factory, factory authorized merchant, or other entity for refurbishment or repair, the distributed ledger maybe updated by the service entity performing refurbishing or repairer as indicated by block 111.

Since it may be desirable to maintain data on some ATM modules until their destructions (for example modules containing encryption modules and/or certificates such as for example an encrypting pin pad “EPP” or an encrypting touch screen “ETS”, storing the end of life of the ATM module can also be done by the distributed ledger 107. In the illustrated example, node 113 updates distributed ledger 107 with end of life data.

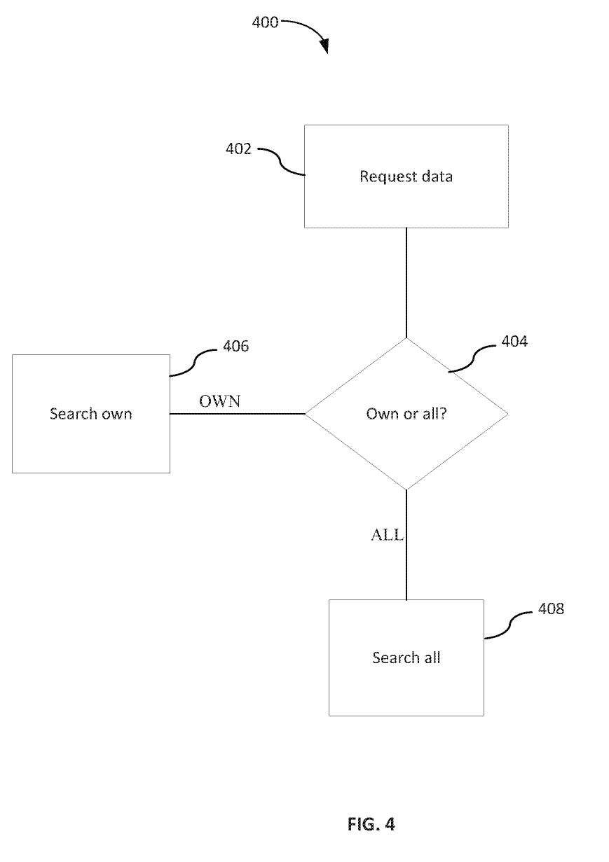

As those skilled in the art can readily appreciate, distributed ledger 107 can be employed for tracking an ATM. Distributed ledger 107 can maintain records for the ATM and for the ATM modules, for example maintain records on which ATM modules are in an ATM and the service records for the individual modules, which also, as will be described in more detail infra (see e.g. FIG. 4) can be aggregated and anonymously searched (e.g., a summary of repair records for a certain type of ATM module may be obtained without revealing the source of the individual records, for example customer A 109A would not which records are from Customer B 109B and/or Customer C 109C.)

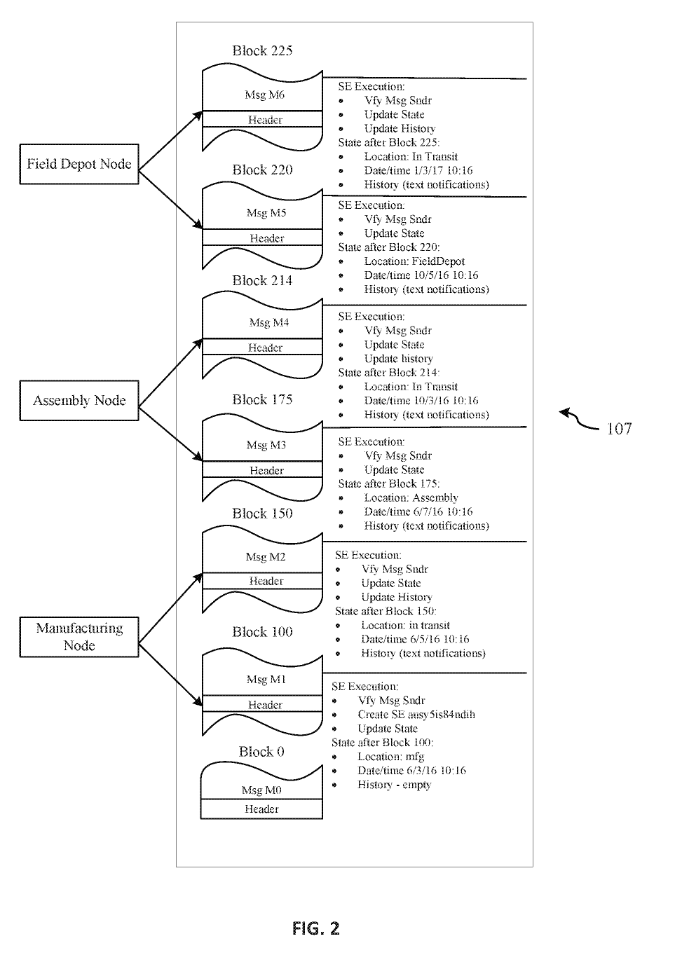

FIG. 2 is an example of data stored in blocks with the chain of custody described in distributed ledger 107 in FIG. 1 For example, Block 0 stores data from message M0 sent by a manufacturing node indicating the location of the ATM module and the date and time the entry was created. Message M1 & M2 from the manufacturing node update the history of the ATM module and are stored in blocks 100 and 150 respectively. Message M2 also indicates the ATM module is in transit. The assembly note updates the chain of custody as indicated by messages M3 and M4 which are stored in blocks 175 and 214 respectively, The Field Depot Node updates the distributed ledger 107 by sending messages M5 and M6 which are stored in blocks 220 and 225 respectively.

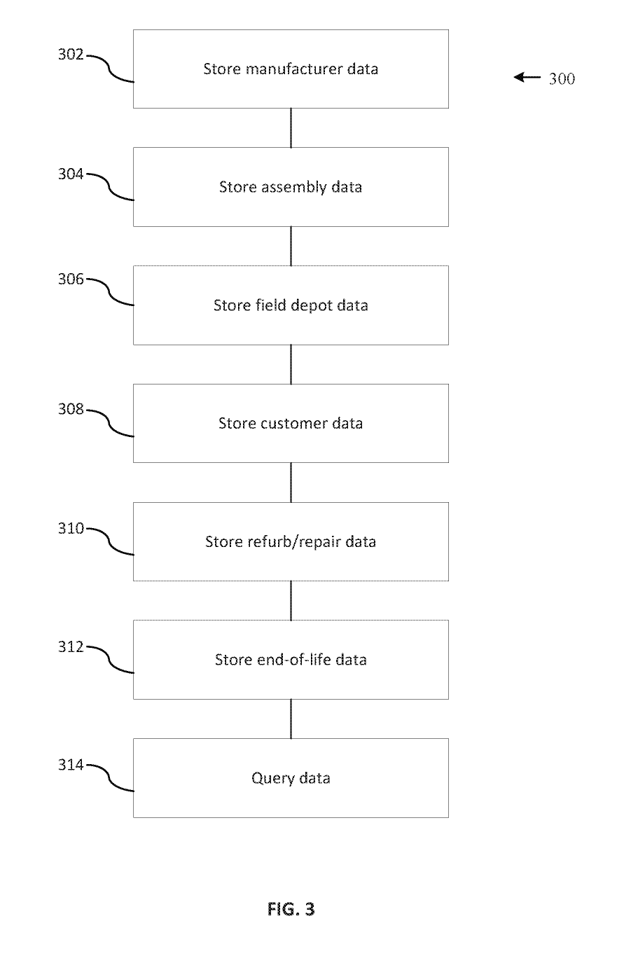

FIG. 3 is an example of a method 300 for employing a distributed ledger for maintaining a chain of custody. While, for purposes of simplicity of explanation, the methodology 300 of FIG. 3 is shown and described as executing serially, it is to be understood and appreciated that the example embodiment is not limited by the illustrated order, as some aspects could occur in different orders and/or concurrently with other aspects from that may or may not be shown and described herein. Moreover, not all illustrated features may be required to implement a methodology in accordance with an aspect of an example embodiment. The methodology 300 described herein is suitably adapted to be implemented in hardware, software when executed by a processor, or a combination thereof.

At 302, manufacturer data is stored in a distributed ledger, such as ledger 107 in FIG. 1. the manufacturer data may include, but is not limited to data representative of a date of manufacture, firmware identification, software identification, or a factory configuration.

At 304, assembly data is received from an assembly node is stored into the distributed ledger. At 306, field depot data received from a field depot node is stored into the distributed ledger.

At 308, customer data is stored into the distributed ledger. The customer data may identify the customer (e.g., the financial institution), In an example embodiment, in the case of an ATM module, the customer and an identification of the machine (ATM) where the module was installed are provided to the distributed ledger.

At 310, refurbishing and repair data are stored in the distributed ledger. This date may be entered by the customer, or by a servicer. The service may be affiliated with the customer, manufacturer or both. When the ATM or ATM module reaches the end of its useful life, end of life data (e.g., where is the ATM or ATM module, or was is destroyed and if so by whom) can be stored into the distributed ledger.

The distributed ledger may be queried as indicated at 314. Although in this example the query is listed at the end of the method, those skilled in the art can readily appreciate that a query may be executed at any time (e.g., while at the manufacturing facility, installed at a customer site, by a service person. The extent of a query may be limited. For example, if customer data is encrypted with the customer's public key, then the customer's private key is employed to read the data so anyone in the chain not having the customer's private key (which could be everyone but the customer). A shared key will allow multiple parties to view the data. For example, a single key may be shared among all nodes allowing all nodes to view the data. In particular embodiments, the manufacturer may share individual keys with individual nodes, the manufacturer can read the entire chain of custody while the individual nodes are limited to their own data.

Financial Institutions that are sharing data are assigned a pseudo identification and at least a key pair (public key and private key). Public keys for the financial institutions are associated with their pseudo identification. The public keys associated with the pseudo names are distributed.

As the financial institution store records in the distributed ledger, they use their pseudo identification as the source of the record. Thus, other financial institutions can access data in the records with the public key having a matching pseudo identification.

FIG. 4 is an example of a method 400 using a distributed ledger for aggregating records in a chain of custody. The method 400 may be implemented by logic in any of nodes Customer A 109A, Customer B 1090, Customer C, or any other node in system 100 described in FIG. 1.

At 402, a request for data from the distributed ledger is received. The request may be for data corresponding to ATM's, ATM components, or combination of ATM components (for example ATM's with a model A cash dispenser and a model A3 controller).

At 404, a determination is made whether the request is for the customer's own records or a search for records from all financial institutions (e.g., is a request from Customer A 109A for only its own records or for records that include Customer B 109B and Customer C 109C). If the determination at 404 is that the request is for the customer's own records (OWN), at 406 the customer's own records are searched.

If, at 404, the determination was made that the customer whishes to search for all records (ALL), at 408 records for the plurality of financial institutions are searched. The records that match the search criteria from all of the plurality of financial institutions are aggregated. The sources of records provided in the aggregated records are the pseudo identifications associated with the other financial institutions. The requestor employs the public keys associated with pseudo identifications corresponding to other of other of the plurality of financial institutions to obtain data from the records from the other of the plurality of financial institutions.

In an example embodiment, at least some of the aggregated records have a second portion of the records have data encrypted by a public key. Thus, the financial institution is able to restrict access to data within a record while allowing the requestor access to portions of the record the financial institution wishes to share.

In an example embodiment, the aggregated records corresponds to components installed in automated teller machines. In particular embodiments, the records correspond to aggregated service records for components installed in a plurality of automated banking machines. Optionally, the requestor may request records for a plurality of components and then compare aggregated service records for components installed in automated banking machines of a first component with aggregated service records for a component.

In an example embodiment, the aggregated records correspond to combination of selected components installed in automated teller machines. In particular embodiments, the records may be service records for the selected combination of components. The aggregated service records correspond to service records for the combination of selected components installed in a first automated teller machine (e.g., a first model type) and service records for the combination of selected components installed in a second automated teller machine (e.g., a second model type).

As those skilled in the art can readily appreciate, this can allow financial institutions to compare equipment and particular configurations across a much broader spectrum than could be accomplished by searching only its own records, while at the same time remaining anonymous as a source of the records. For example, a financial institution can determine that certain combinations of components require more service than other combination of components.

In an example embodiment, a financial institution may employ a distributed network for implementing smart contracts. The network has nodes comprising ATMs (Lite Nodes), Financial Institution (FI) facilities (Full Nodes) that manage the micro-loans available at the ATM and any other FI facility (Partial Node) that might need to review the history of the Micro-Loans.

Full and Partial nodes comprise logic that maintains a synchronized local copy of a “Distributed Ledger” which is used to immutably manage and record the Micro-Loans originating at the ATM. Lite Nodes connect to the network but do not contain copies of the ledger.

In an example embodiment, nodes are connected to a subset of peer nodes in the network. Messages produced by a node are distributed to all nodes that it is connected to. Its connection nodes perform basic validation of all incoming messages and pass it on to the subset of nodes that they are connected to. Eventually all nodes will have received messages from all nodes. These messages are collected at each node in to a message pool.

Each node on the network uses Public Key Infrastructure (PKI) cryptography to interact with other nodes and the ledger. Each node creates a private and public key pair where the public key is used to produce a unique network address to represent its self on the network. This address is used at the target address in message interchanges. The private key is hashed (e.g., SHA256) with any message data that will be sent on the network to form a per transaction unique digital signature that can be verified by a receiver to establish trust.

When a Customer approaches an ATM that supports Micro-Loans, presents their credentials (inserts ATM card, taps smart phone) and selects a “Micro-Loan” transaction from the list of available transactions. A Micro-Loan can be a loan similar to what are frequently referred to as “payday loans” which are under a preset threshold (e.g., less than $1,000) and less than a predefined time period (e.g., 30 days). The financial institution may set the preset threshold and predefined time period by customer (e.g., a new customer with little credit history may be have a lower amount limit and/or time limit then a well established customer). The ATM collects additional details such as amount, phone number and makes customer aware of the terms of the loan. Once the customer agrees to the terms the ATM dispenses the agreed upon amount and prints a receipt indicating a loan number and the terms.

Once the cash is dispensed the ATM sends a message to the FI node that is managing Micro-Loans for this ATM. The message provides all of the information necessary to establish, monitor and maintain the loan. The customer phone number is used to send the customer text messages making them aware of the state of the loan throughout the life cycle of the loan.

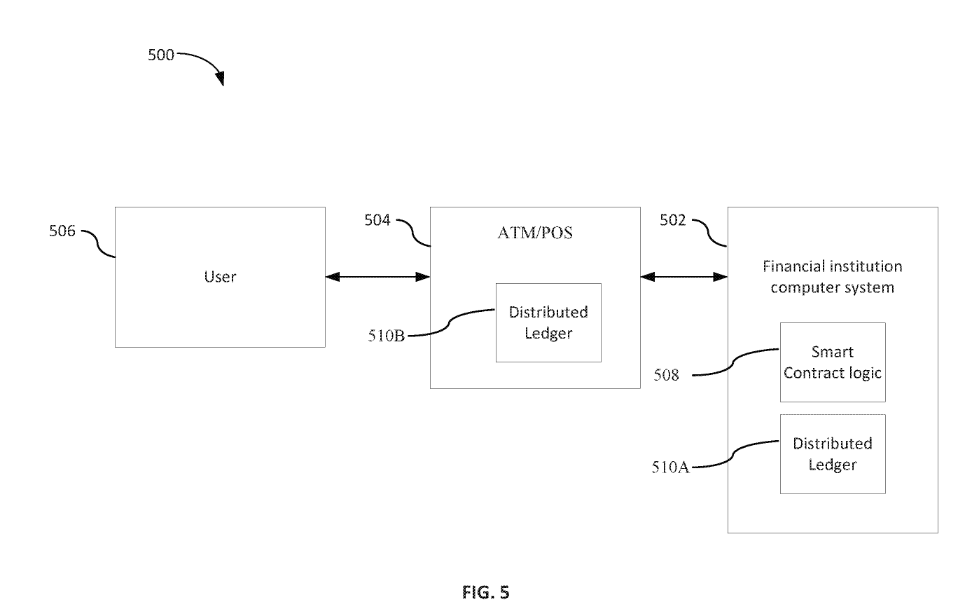

FIG. 5 is a block diagram illustrating an example of a system 500 using a distributed ledger for a smart contract. A financial institution computer system 500 is coupled to an automated teller machine (ATM) or a point of sale (POS) terminal 504 (hereinafter referred to as an ATM). Synchronized distributed ledgers are represented by 510A at the financial institution computer system 502 and 510B at the ATM 504.

A user (customer) 506, approaches the ATM 504 and requests a loan application. The user enters the data and the loan application is forwarded to the smart contract logic 508 in the financial institutions computer system 502. If the loan is approved, if not already provided, the terms of the loan our output by the ATM 504 and the user 506 can assent to the terms via ATM 504. The ATM then provides funds to the user 506. Data representative of the loan is stored in the distributed ledgers 510A and 510B.

In the future, the user 502 may employ ATM 504 (or a different ATM coupled with the financial institution computer system 502) to make payments to the loan. Alternatively, the user 502 may make payments via other methods (e.g., mail a payment to the financial institution or give the payment to a teller at one of the financial institution's branches which will cause the distributed ledger 510A, 510B to be updated.

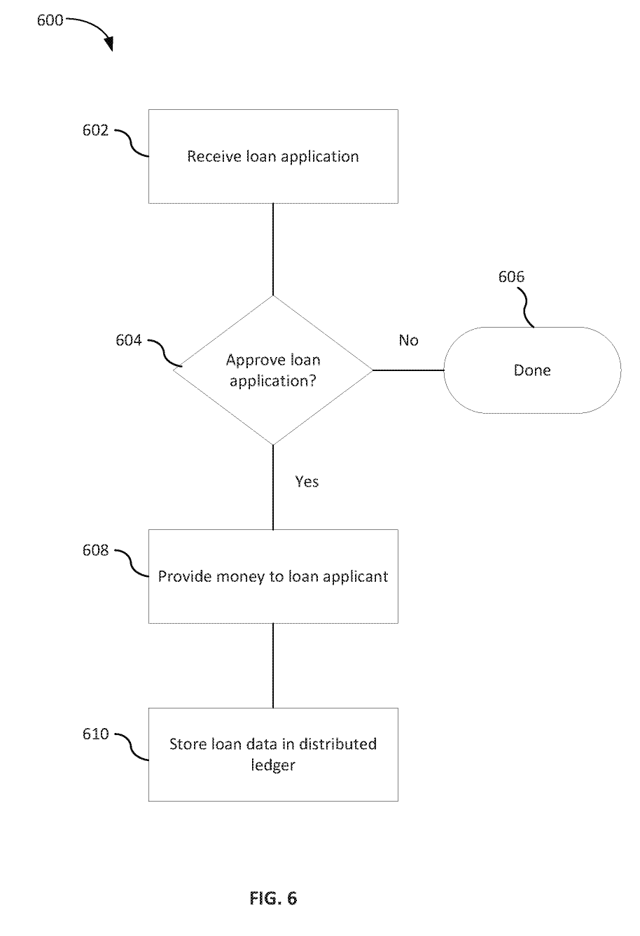

FIG. 6 is an example of a method of using a distributed ledger for smart contracts. This method may be implemented by smart contract logic 508 (FIG. 5).

A customer fills out a loan application at a terminal such as for example an ATM or POS terminal (e.g., 504 in FIG. 5). The terminal may provide available amounts, terms (e.g., amount, number, and time period for payments), and other pertinent information. After the application is filled out, at 602, the loan application is received for processing.

At 604, a determination is made whether the loan is approved. If the loan is not approved, at 606, the method is stops.

At 608, the funds are provided to the customer. For example, referring to FIG. 5, smart contract logic 508 may send instructions to ATM to dispense cash corresponding to the loan amount. If the terms of the loan have

At 610, the loan data is stored in the distributed ledger. The customer may also request a printout of the loan terms which may be printed out by the ATM.

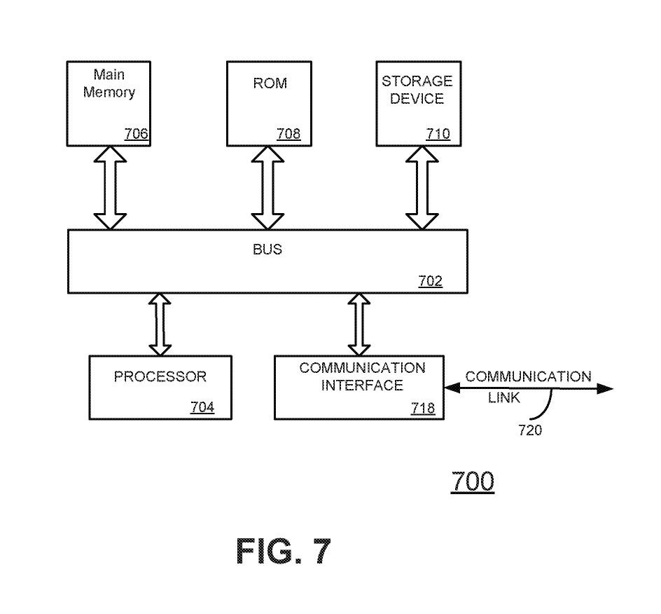

FIG. 7 is an example of a computer system 700 upon which an example embodiment is implemented. Computer system 700 may be employed to implement any of nodes 101, 103, 107, 109A, 190B, 109C, 111, 113, and distributed ledger 107, and smart contract logic 708 (FIG. 7). Computer system 700 may also be employed to implement methodologies 300 (FIG. 3), 400 (FIG. 4), and 600 (FIG. 6).

Computer system 700 includes a bus 702 or other communication mechanism for communicating information and a processor 704 coupled with bus 702 for processing information. Computer system 700 also includes a main memory 706, such as random access memory (RAM) or other dynamic storage device coupled to bus 702 for storing information and instructions to be executed by processor 704. Main memory 706 also may be used for storing a temporary variable or other intermediate information during execution of instructions to be executed by processor 704. Computer system 700 further includes a read only memory (ROM) 708 or other static storage device coupled to bus 702 for storing static information and instructions for processor 704. A storage device 710, such as a magnetic disk or optical disk, is provided and coupled to bus 702 for storing information and instructions.

An aspect of the example embodiment is related to the use of computer system 700 for using a distributed ledger to manage debt data. According to an example embodiment, using a distributed ledger to manage debt data is provided by computer system 700 in response to processor 704 executing one or more sequences of one or more instructions contained in main memory 706. Such instructions may be read into main memory 706 from another computer-readable medium, such as storage device 710. Execution of the sequence of instructions contained in main memory 706 causes processor 704 to perform the process steps described herein. One or more processors in a multi-processing arrangement may also be employed to execute the sequences of instructions contained in main memory 706. In alternative embodiments, hard-wired circuitry may be used in place of or in combination with software instructions to implement an example embodiment. Thus, embodiments described herein are not limited to any specific combination of hardware circuitry and software.

The term “computer-readable medium” as used herein refers to any medium that participates in providing instructions to processor 704 for execution. Such a medium may take many forms, including but not limited to non-volatile media. Non-volatile media includes for example optical or magnetic disks, such as storage device 710. Common forms of computer-readable media include for example floppy disk, a flexible disk, hard disk, magnetic cards, paper tape, any other physical medium with patterns of holes, a RAM, a PROM, an EPROM, a FLASHPROM, CD, DVD, memory stick or any other memory chip or cartridge, or any other medium from which a computer can read.

In an example embodiment, storage device 710 may contain at least a portion of distributed ledger data. In particular embodiments, storage device 710 contains a copy of the distributed ledger.

Computer system 700 also includes a communication interface 718 coupled to bus 702. Communication interface 718 provides a two-way data communication coupling computer system 700 to a network link 720 that is connected to a network, such as a local area network, wireless network, and/or the Internet.

For example, communication interface 718 may be a local area network (LAN) card to provide a data communication connection to a compatible LAN. As another example, communication interface 718 may be an integrated services digital network (ISDN) card or a modem to provide a data communication connection to a corresponding type of telephone line. Wireless links may also be implemented. In any such implementation, communication interface 718 sends and receives electrical, electromagnetic, or optical signals that carry digital data streams representing various types of information.

Described above are example embodiments. It is, of course, not possible to describe every conceivable combination of components or methodologies, but one of ordinary skill in the art will recognize that many further combinations and permutations of the example embodiments are possible. Accordingly, this application is intended to embrace all such alterations, modifications and variations that fall within the spirit and scope of the appended claims interpreted in accordance with the breadth to which they are fairly, legally and equitably entitled.

1-10. (canceled)

11. An apparatus, comprising:
a distributed ledger;
a manufacturer node coupled with the distributed ledger;
a plurality of customer nodes coupled with the distributed ledger;
the manufacturer node is operable to cause a record to be created in the in the distributed ledger, the record comprising data representative of an automated teller machine module entering a supply chain;
a first of the plurality of customer nodes is operable to store data into the distributed ledger identifying a first automated banking machine where the module has been installed responsive to the automated banking machine module being installed into the first automated banking machine;
the first of the plurality of customer nodes is further operable to store service data for the automated banking machine module while the module is installed in the first automated banking machine into the distributed ledger;
a second of the plurality of customer nodes is operable to store data into the distributed ledger identifying a second automated banking machine where the module has been installed responsive to the automated banking machine module being installed into the second automated banking machine;
the second of the plurality of customer nodes is further operable to store service data for the module while the module is installed in the second automated banking machine into the distributed ledger; and
the distribution ledger is operable to selectively limit service data provided based on a type of node requesting the service data.

12. The apparatus set forth in claim 11, wherein the manufacturer node is provided with all service data provided by the first and second customer nodes; and
wherein the first node is selectively provided with service data originating from the first node and is not provided with service data from the second node.

13. The apparatus set forth in claim 11, wherein the manufacturer node is provide with all service data provided by the first and second customer nodes;
wherein the first node is selectively provided with service data originating from the first node and second node; and
wherein the service data provided to the first node does not contain an origin for service data originating from the second node.

14. The apparatus set forth in claim 11, wherein the distributed ledger is operable to enable the first node to select whether to retrieve data originating from the first node and data originating from all nodes.

15. The apparatus set forth in claim 11, wherein the data representative of an automated teller machine module comprises a unique identifier.

16. The apparatus set forth in claim 15, wherein the service data comprises a unique identifier; and
the distributed ledger is operable to store the service data responsive to determining the unique identifier in the service data matches the unique identifier of the automated teller machine module.

17. The apparatus set forth in claim 16, wherein the service data comprises data representative of a location of the automated teller machine module.

18. The apparatus set forth in claim 17, wherein the service data comprises data representative of an identifier for the automated teller machine where the automated teller machine module is installed.

19. The apparatus set forth in claim 11, wherein the distributed ledger is operable to store data indicating an end of life for the automated banking machine component received from a node.

20. The apparatus set forth in claim 19, wherein the automated banking machine component is selected from a group consisting of an encrypting personal identification number pad and an encrypting touch screen.

21. A method, comprising:
storing manufacture data received from a manufacturing node into a distributed ledger, the manufacture data comprises data representative of an automated teller machine module entering a supply chain;
storing customer data from a plurality of customer nodes, the customer data comprises service data;
selectively providing customer data based on a type of node requesting the service data in response to an inquiry.

22. The method set forth in claim 21, wherein the manufacturer node is provided with all customer data provided by all nodes; and
wherein a first customer node from the plurality of customer nodes is selectively provided with customer data originating from the first customer node and is not provided with customer data from any other of the plurality of customer nodes.

23. The method set forth in claim 21, wherein the manufacturer node is provide with all customer data provided by all nodes;
wherein a first node of the plurality of customer nodes is selectively provided with customer data originating from all of the plurality of customer nodes; and
wherein the customer data provided to the first node does not contain an origin for customer data originating from any other of the plurality of customer nodes.

24. The method set forth in claim 21, wherein the distributed ledger is operable to enable a first node from the plurality of nodes to select whether to retrieve data originating from the first node and data originating from all nodes.

25. The method set forth in claim 21, wherein the data representative of an automated teller machine module comprises a unique identifier.

26. The method set forth in claim 25, wherein the service data comprises a unique identifier; and
the distributed ledger is operable to store the service data responsive to determining the unique identifier in the service data matches the unique identifier of the automated teller machine module.

27. The method set forth in claim 26, wherein the service data comprises data representative of a location of the automated teller machine module.

28. The method set forth in claim 27, wherein the service data comprises data representative of an identifier for the automated teller machine where the automated teller machine module is installed.

29. The method set forth in claim 21, wherein the distributed ledger is operable to store data indicating an end of life for the automated banking machine component received from a node.

30. The method set forth in claim 29, wherein the automated banking machine component is selected from a group consisting of an encrypting personal identification number pad and an encrypting touch screen.
